(19) United States
(12) Patent Application Publication
(10) Pub. No.: US 2022/0138927 A1
(43) Pub. Date: May 5, 2022

(54) AUTOMATED DETERMINATION OF LOCATIONS OF DONOR ATOMS

(71) Applicant: The University of Melbourne, The University of Melbourne, Victoria (AU)

(72) Inventors: Lloyd Christopher Leonard Hollenberg, Melbourne (AU); Muhammad Usman, Melbourne (AU); Yi Zheng Wong, Melbourne (AU)

(21) Appl. No.: 17/435,351

(22) PCT Filed: Feb. 27, 2020
(86) PCT No.: PCT/AU2020/050174

§ 371 Date: Aug. 31, 2021

(30) Foreign Application Priority Data
Mar. 1, 2019 (AU) 2019900677

(51) Int. Cl. G06T 7/00

(52) U.S. Cl. CPC G06T 7/0004; G06T 2207/20081; G06T 2207/30148; G06T 2207/10056; G06T 2207/20084

(57) ABSTRACT

This disclosure relates to automatic determination of locations of one or more closely spaced donor atoms implanted into a semiconductor crystal lattice. A processor receives image data generated by a scanning tunnelling microscope (STM). The image data is indicative of a tunnelling current between a scanning tip and the crystal lattice at multiple image locations. The processor applies a trained machine learning model to the image data to determine a classification into one of multiple candidate configurations of the one or more donor atoms. The multiple candidate configurations relate to different locations of the one or more donor atoms in the semiconductor crystal lattice. Based on an output of the trained machine learning model, the processor determines the location of the one or more donor atoms in the semiconductor crystal lattice.

### CROSS-REFERENCE TO RELATED APPLICATIONS

The present application claims priority from Australian Provisional Patent Application No 2019900677 filed on 1 Mar. 2019, the contents of which are incorporated herein by reference in their entirety.

### TECHNICAL FIELD

This disclosure relates to the automated determination of location(s) of donor atom(s) in a semiconductor crystal lattice.

### BACKGROUND

Dopant spins in silicon provide a promising platform for a variety of applications in spintronics and valleytronics areas of research. In particular, the associated long coherence times for nuclear and electron spins have sparked tremendous research interests to operate them as qubits, which are the building blocks of a scalable quantum computer architecture. A surface code architecture scheme, which offers exceptional error correction threshold, may consist of a two-dimensional array of P dopant atoms in Si crystal surrounded by the control gates. In this scheme, the precision placement of dopant atoms with respect to each other and to the control gates is important for the design and implementation of robust high-fidelity quantum operations. Even an uncertainty in dopant number and positions as small as one lattice site variation may reduce the two-qubit fidelities below that required by the quantum error correction threshold. Therefore, there is a need for a technique to determine locations of donor atoms with a high accuracy and the scalability towards millions of qubits which will enable the design of large-scale quantum computer architectures.

Further, it is expected that an STM fabricated device may consist of qubits based on a mixture of single dopants and closely-spaced dopant clusters. The number of possible locations in closely-spaced clusters exponentially increases with the number of dopants forming the cluster. For instance, for the clusters consisting of merely two dopant atoms, the number of distinct possible locations within 5 nm from the surface would be 1250, compared to merely 60 possible locations for a single dopant atom. With these large number of possibilities for qubit formation, it becomes impractical to apply direct pixel-by-pixel comparison approach, or by a direct spectroscopic approach [Yu Wang, Chin-Yi Chen, Gerhard Klimeck, Michelle Y. Simmons & Rajib Rahman, Characterizing Si:P quantum dot qubits with spin resonance techniques, Scientific Reports 6 31830 (2016)].

J. Salfi, J. Mol, R. Rahman, G. Klimeck, M. Simmons, L. Hollenberg, S. Rogge, Spatially resolving valley quantum interference of a donor in silicon, Nature Materials 13 6 (2014); discloses the use of STM to image donor states close to the silicon surface, and the subsequent analysis of their valley degrees of freedom by tight-binding simulations. M. Usman, J. Bocquel, J. Salfi, B. Voisin, A. Tankasala, R. Rahman, M. Y. Simmons, S. Rogge & L. C. L. Hollenberg, Spatial metrology of dopants in silicon with exact lattice site precision, Nature Nanotechnology volume 11, pages 763-768 (2016); discloses a known metrology combining low-temperature scanning tunnelling microscopy (STM) imaging (in the aforementioned J. Salfi et al Nature Materials 2014) and a comprehensive quantum treatment of the dopant-STM system to pinpoint the exact coordinates of the dopant in the Si crystal. This method is based on a rigorous and computationally expensive pixel-by-pixel match between the measured and computed images, enabling the unambiguous pinpointing of the exact dopant lattice site position. This method, however, is computationally impractical to apply to large scale applications with many qubits and potentially multiple closely spaced donors.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The words “donor” and “dopant” are interchangeable.

### SUMMARY

There is provided a method for automatic determination of locations of one or more closely spaced donor atoms implanted into a semiconductor crystal lattice. The method comprises:

receiving image data generated by a scanning tunnelling microscope (STM), the image data being indicative of a tunnelling current between a scanning tip and the crystal lattice at multiple image locations;

applying a trained machine learning model to the image data to determine a classification into one of multiple candidate configurations of the one or more donor atoms, wherein the multiple candidate configurations relate to different locations of the one or more donor atoms in the semiconductor crystal lattice; and

based on an output of the trained machine learning model, determining the location of the one or more donor atoms in the semiconductor crystal lattice.

It is difficult to determine the location of multiple donor atoms since the resulting STM images of different locations look very similar to the human eye. Further, for an error-corrected surface code architecture, there will be a 2D array of qubits containing millions of donor atoms. It would be impractical to characterise all qubits based on individual iterations. The above machine learning approach allows automatic and robust determination of locations. More particularly, the specific setup of the trained machine learning (ML) model is such that the ML model classifies the image data into configurations that, in turn, relate to locations of the multiple donors. This is an advantage that is specific to the application to semiconductor crystal lattices because the donor atoms are typically located at discrete locations within the lattice. The presence of multiple atoms leads to many combinations of possible locations that are difficult to distinguish from the STM images. However, the above ML method provides for accurate determination of the location of individual donor locations and is applicable to automatic assessment of large-scale qubit arrays.

The semiconductor crystal lattice may form dimer rows of dimer row atoms and the trained machine learning model may use features that are based on an intensity of individual dimer row atom features in the image data.

The trained machine learning model may generate an output that is indicative of a selected one of the multiple candidate configurations and the location may be determined as the location related to the selected one of the multiple candidate configurations.

The trained machine learning model may be trained using training samples and the training samples may be labelled with identifiers of the multiple candidate configurations.

The multiple candidate configurations may be based on a symmetry of locations of the multiple donor atoms. The symmetry may be in relation to a dimer row. The symmetry may be defined by one or more symmetry axes that are parallel and normal to the dimer row, respectively. The method may further comprise applying the symmetry to reduce a number of training images.

The image data may cover a cluster of multiple donor atoms and the multiple candidate configurations may relate to how many donor atoms are in the cluster of donor atoms and the method may comprise based on an output of the trained machine learning model, determining how many donor atoms are in the cluster. The multiple candidate configurations may be related to two donors with one shared electron.

The two donor locations may be constrained by one or more of the following constraints:

the multiple donor atoms are in the same layer; and

the distance between the multiple donor atoms is 1 or more lattice sites.

The two donors may comprise a first donor and a second donor. The trained machine learning model may use numeric labels. The numeric labels may be indicative of a relative position of the second donor relative to the first donor.

The method may comprise training an untrained machine learning model to obtain the trained machine learning model based on one or more of:

experimental STM images;

spectroscopic measurements; and

simulated STM images comprising simulated noise, or both.

The simulated noise may be based on a planar variation where a gradient across the simulated STM images defines a difference in percentage variation. The method may comprise generating the simulated images for different values of the planar variation. The method may comprise blurring or otherwise manipulating the simulated images for different amounts of symmetrical or elliptical blurring or other manipulation typical of experimental effects.

The trained machine learning model may use features that are based on one or more of:

rotated images to align a dimer row between multiple images;

feature detected edges; and

images with empty spaces removed.

The trained machine learning model may use features that are based on averages across dimer rows and atoms along the dimer rows.

The averages may form low-resolution two-dimensional images with the dimer rows and atoms as respective dimensions and the trained machine learning model may use the low-resolution two-dimensional images as features.

There is also provided a computer system for automatic determination of locations of one or more closely spaced donor atoms implanted into a semiconductor crystal lattice. The computer system comprises:

a memory to store or an input port to receive image data generated by a scanning tunnelling microscope (STM), the image data being indicative of a tunnelling current between a scanning tip and the crystal lattice at multiple image locations; and

a processor programmed to:
apply a trained machine learning model to the image data to determine a classification into one of multiple candidate configurations of the one or more donor atoms, wherein the multiple candidate configurations relate to different locations of the one or more donor atoms in the semiconductor crystal lattice, and
based on an output of the trained machine learning model, determine the location of the one or more donor atoms in the semiconductor crystal lattice. Optional features described of any aspect of method, computer readable medium or computer system, where appropriate, similarly apply to the other aspects also described here.

### BRIEF DESCRIPTION OF DRAWINGS

An example will now be described with reference to the following drawings:

FIG. 1 illustrates a method for measuring locations of single and multiple closely spaced donor atoms.

FIG. 2 illustrates a schematic of evaluation of STM current image using Bardeen's tunneling matrix element with donor wavefunction Ψᵥ and tip state Ψ_{μ} across surface.

FIG. 3 illustrates a unit cell of silicon formed by two penetrating face cantered cubic (FCC) lattices with the cube side length being 0.5431 nm.

FIG. 4 shows four layers of atoms with repeating patterns of the silicon atoms in a diamond cubic structure.

FIG. 5 illustrates dimer rows. Si atoms on the surface form dimer rows, where instead of being evenly spaced apart, pairs of Si atoms are closer to each other forming a 2×1 reconstructed surface.

FIG. 6 is a plot of Si atoms (dots) along the [001] plane with silicon dimer rows (circle) on surface. As an example, atoms at four depths (4a₀, 4.25a₀, 4.5a₀, 4.75a₀) from the surface are shown, where a₀ is silicon lattice constant (0.5431 nm).

FIGS. 7a-7c illustrates the disclosed symmetry analysis and classification of STM images: FIG. 7a: Schematic diagram of a small portion of the silicon lattice is shown and the positioning of phosphorus (P) donor atoms (Side View), defining the integers m and i. FIG. 7b: Top View, exhibiting atom positions in the selected six planes, defining the counting of second donor locations via the integer j (j=0 corresponds to the single donor case), all j values shown explicitly for the m=0 case with the starting values shown for the other m-cases. FIG. 7c: Theoretically computed STM images are plotted for all possible position combinations (j=0, 1, 2, . . . , 24) at n=4, m=3/4, and i=7. The images clearly exhibit well-defined symmetry of wave functions convoluted with surface dimer positions. Based on symmetry analysis, the 2P images appear identical when the second phosphorus atom is symmetrically distributed around the reference phosphorus atom at j=0. All distinct images are marked by “X”.

FIG. 8 shows a flow chart diagram of machine learning framework: a. For the demonstration of the working of the machine learning framework, an example STM image is selected corresponding to n=4, m=3/4, i=7, and j=2. The STM image is converted from RGB color plot to grayscale color plot to reduce the storage size. The STM image is further processed to extract either edges of bright feature identified by edges or the averaging over each bright feature. Kernels are shown with size 32 for edge detection or 16 for feature averaging scheme. The images are convoluted with the kernels to generate 32 (or 16) convoluted images. The convoluted images train a neural network with one input layer, one hidden layer, and one output layer. The outcomes of trained neural network classifies the STM images in accordance with exact P donor atom positions and count.

FIG. 9 illustrates test results from the machine learning framework: a. The fidelity of machine learning framework to identify donor locations b. A set of 16 processed STM images by the application of edge detection procedure for feature detection to test the working of the formulated ML framework. In each case, the ML framework correctly identified the donor positions. c. A set of 16 processed STM images by the application of feature averaging procedure for the feature detection to test the working of the formulated ML framework. In each case, the ML framework correctly identified the donor positions.

FIG. 10 shows an example case for an STM image corresponding to n=4, m=3/4, i=7, and j=4. The dotted line indicates a diagonal axis parallel to the surface dimer rows. The image is reflected about the green axis in (b), which is now same as the STM image computed for the position corresponding to n=4, m=3/4, i=7, and j=8.

FIG. 11 shows theoretically computed STM images for all possible positions (j=0, 1, 2, . . . , 24) at n=4, m=0, and i=1. The images clearly exhibit well-defined symmetry of the wave functions convoluted with surface dimer positions. Based on symmetry analysis, the 2P images appear identical when the second phosphorus atom is symmetrically distributed around the reference phosphorus atom at j=0. The distinct images are marked with “X”

FIG. 12 shows theoretically computed STM images for all possible positions (j=0, 1, 2, . . . , 24) at n=4, m=1/4, and i=3. The images clearly exhibit well-defined symmetry of the wave functions convoluted with surface dimer positions. Based on symmetry analysis, the 2P images appear identical when the second phosphorus atom is symmetrically distributed around the reference phosphorus atom at j=0. The distinct images are marked with “X”.

FIG. 13 shows theoretically computed STM images for all possible positions (j=0, 1, 2, . . . , 24) at n=4, m=1/2, and i=5. The images clearly exhibit well-defined symmetry of the wave functions convoluted with surface dimer positions. Based on symmetry analysis, the 2P images appear identical when the second phosphorus atom is symmetrically distributed around the reference phosphorus atom at j=0. The distinct images are marked with “X”.

FIG. 14 shows theoretically computed STM images for all possible positions (j=0, 1, 2, . . . , 24) at n=4, m=1/4, and i=6. The images clearly exhibit well-defined symmetry of the wave functions convoluted with surface dimer positions. Based on symmetry analysis, the 2P images appear identical when the second phosphorus atom is symmetrically distributed around the reference phosphorus atom at j=0. The distinct images are marked with “X”.

FIG. 15 shows theoretically computed STM images for all possible positions (j=0, 1, 2, . . . , 24) at n=4, m=3/4, and i=8. The images clearly exhibit well-defined symmetry of the wave functions convoluted with surface dimer positions. Based on symmetry analysis, the 2P images appear identical when the second phosphorus atom is symmetrically distributed around the reference phosphorus atom at j=0. The distinct images are marked with “X”.

FIG. 16 illustrates an example of planar variation, where contours of percentage variation are plotted. On the upper side the image is brighter, while the lower side the image is darker.

FIG. 17 illustrates the evaluation of the Gaussian blurring kernel, where x and y are the displacements from the centre, with σ_{B} is the blurring level based on the number of pixels.

FIG. 18 illustrates a flow chart diagram of STM image processing for the edge detection case for a sample image corresponding to the position (m,n,i,j)=(1/2,4,8,5). The original grey scale image is 535×535 pixel size. The image is rotated clockwise by 45° and the black space region (negligible tunnelling current) is cropped. The new image is 237×189 pixels size and only consists of bright features in the image. The application of edge detection operation is applied to highlight the edges of the bright features. In the final step, a max-pooling function is applied to further reduce the size of image to 79×63 pixels.

FIG. 19 Flow chart diagram of feature averaging procedure for a sample STM image corresponding to position (m,n,i,j)=(0,4,1,8). A grayscale STM image consists of 535×535 pixels. The image is rotated clockwise by 45° and the black pixels corresponding to negligible tunnelling current are cropped, reducing the size of STM image to 237×189. The bright features correspond to the position of surface silicon atoms in the form of dimer rows. The circles indicate the positioning of dimer rows with respect to the bright features in the STM image. The placement of circles is based on the exact locations of silicon atoms in the dimer rows. These atom positions may be computed based on 2×1 reconstruction scheme, determined directly from experimental inputs. For this particular STM image, there are 11×10 dimer row atoms shown by the circles. The average value of pixels in each red circle is computed to form a new image representation consisting of only 11×10 pixels.

FIG. 20 shows plots of fidelities as a function of the blurring noise for a set of selected donor images corresponding to donor positions identified by (m,n,i,j). The CNN identifies the correct donor positions with 100% fidelities in all cases when the noise level is below 1.0. The fidelities become small for higher noise levels. The results show that the rate of fidelity drop is different for different STM images at the same noise level, indicating that the machine learning identification may be dependent on the target depth for qubit fabrication.

FIG. 21 shows a set of sixteen STM images corresponding to donor locations marked with the descriptor (m, n, i, j) to test the fidelity of machine learning framework. Each image is processed as described herein and perturbed with random planar (0<σ_{P}<0.2) and blurring (0<(σ_{B}<3.0) noise values.

FIG. 22 illustrates a computer system for automated metrology of locations of single and multiple closely spaced donor atoms implanted into a semiconductor crystal lattice.

### DESCRIPTION OF EMBODIMENTS

This disclosure provides an automated technique for determining locations of donors based on an efficient theoretical framework, which combines the computed, or a combination of computed and experimental, STM images of dopant atom wave functions with the machine learning tools. “Automated” in this context means that the method can be performed entirely by machines, such as computers, such that human interaction is not necessary anymore or the necessary human interaction is reduced a minimum. This allows assessment of large fabricated arrays of donor systems with limited human resources. The method is applicable to donors fabricated in silicon by both ion implantation and STM lithography techniques. The methodology may be based on a convolutional neural network (CNN), or other automated image recognition system, that is trained to recognise STM image features and associate the corresponding dopant number and dopant positions with high throughput and fidelity. In one example, STM images are computed corresponding to all possible single dopant atoms and clusters of two closely-spaced dopants. The images are processed to reduce the computational burden by extracting features and perturbed by addition of realistic noise levels. The large number of images are used to train a CNN with three layers (input, hidden, and output layers). The trained CNN identifies the exact lattice site position(s) of dopant atom(s) corresponding to each test STM image. The overall fidelity of this method may be above 99% in all cases studied in this work.

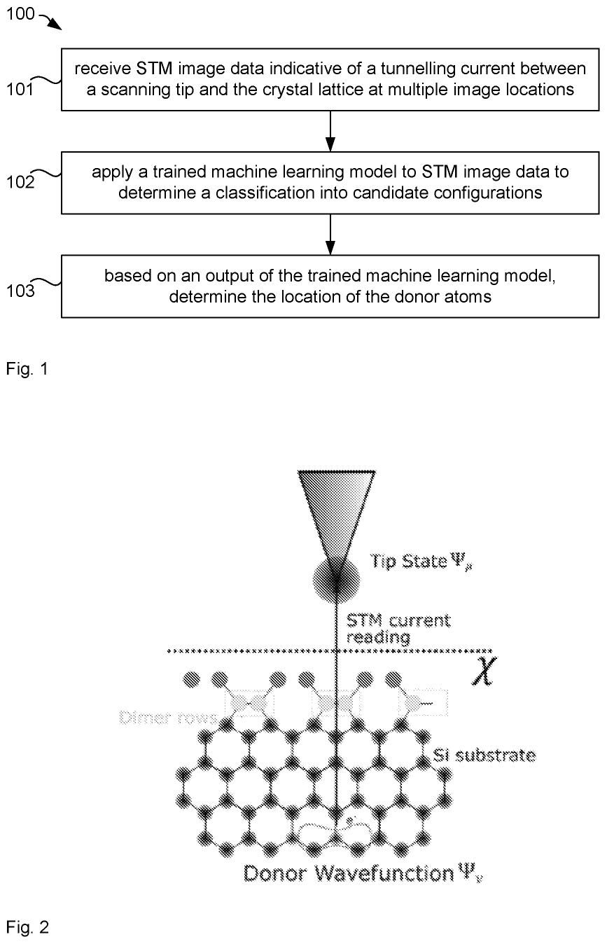

FIG. 1 illustrates a method 100 for determining locations of one or more donor atoms implanted into a semiconductor crystal lattice. In some examples the crystal lattice is a silicon crystal lattice and the donor atoms are phosphoros atoms. However, other combinations are equally possible, such as involving other group V donors or other substrates including germinium and III-V materials. The implantation may be achieved using STM fabrication, ion implantation, STM lithography, and other methods. In one example, there are multiple closely spaced donors to be located. “Closely spaced” in this context means that the donors interact in the sense that they can provide qubit functionality between them or that their wave functions overlap significantly. This interaction may be tunable and in some architectures, the closely spaced donors are typically spaced from one another by just a few lattice sites (or less than 1 nm in other examples). While this method is useful for two or more closely-spaced donor atoms, it can equally be applied to single donor atoms, or generalised to higher numbers of donor atoms. Further, in some examples, the training data includes experimental STM images, which may be labelled manually or automatically. The training data may further include spectroscopic metrology techniques [Yu Wang, Chin-Yi Chen, Gerhard Klimeck, Michelle Y. Simmons & Rajib Rahman, Characterizing Si:P quantum dot qubits with spin resonance techniques, Scientific Reports 6 31830 (2016)].

Method 100 commences by receiving image data generated by a scanning tunnelling microscope (STM). This image data may be generated off-site and received from a data memory or the internet. The image data is indicative of a tunnelling current between a scanning tip and the crystal lattice at multiple image locations, scanning over each qubit. Method 100 continues by applying 102 a trained machine learning model to STM image data. In some examples described herein, the trained machine learning model is a convolutional neural network and that may involve Google's TensorFlow package. In other examples, however, other models including linear regression classifiers or other models may be used. In essence, a machine learning model is a mathematical way of calculating an output value based on multiple inputs. This calculation uses multiple parameters that may weight or otherwise process the inputs. The values of these parameters are optimised based on training samples where the inputs and the output is known such that the calculated output is as close as possible to the known output for all training samples.

In this way, the application of the trained machine learning model determines a classification of the STM images into one of multiple candidate configurations of the donor atoms (“classes”). The multiple candidate configurations relate to different locations of the one or more donor atoms in the semiconductor crystal lattice. For example, one candidate configuration may be that both donor atoms are exactly one lattice site apart from each other. While some examples herein relate to pairs of donor atoms and the machine learning model is trained on training images for pairs, it is equally possible to train the machine learning model on training images with single donor atoms or with different numbers of donor atoms. In that case, selecting one of the candidate configurations not only identifies the locations of the donor atoms but also the number of donor atoms in the cluster.

Based on an output of the trained machine learning model, method 100 determines 103 the location and number of the multiple donor atoms in the semiconductor crystal lattice. For example, the trained machine learning model may generate a number value that identifies the particular candidate and then, determining the location is a look-up in a list that stores the candidates together with associated locations.

### STM Functioning

STM works by scanning a sharp metallic tip across an atomic surface, leaving a very small gap in between under ultra-high vacuum to avoid imperfection. With a bias applied, electrons will flow through due to the quantum tunneling process as the gap in between tip and surface serves as a potential barrier, resulting in an electrical current shown in FIG. 2. Simplistically speaking, the current will depend on the gap distance exponentially:

I∝exp(−2kd)

Where I is the current, d is the gap distance and k is the decay constant given by

$$k = \frac{\sqrt{2 m ϕ}}{ℏ}$$

with m and ϕ being the electron's mass and effective local work function.

The probe is then moved across the surface, and the structure of the surface can be resolved either in the constant current mode where the probe moves along the surface, and continuously adjust the length of the gap till a constant current is achieved, the variation of the length of the gap is then recorded since current depends on the length; or in the constant height mode where the probe simply moves along the surface and the variation of current is recorded. The recorded variation in either height or current can then be plotted out, which corresponds to the shape of the scanned surface.

Generally speaking, the equation above may be too simplistic and may only work in situations where there are free electrons lying on the surface such as metals. In this disclosure, concerning donor atoms (such as phosphorus P) in silicon where one or more of the Si atoms are replaced with the P atom, there is an absence of free electrons on its surface as majority of the electrons are bounded to the silicon atoms. Hence the only electron that will provide the measured STM current is the loosely bounded electron on the phosphorus donor.

In this case, the STM current can be calculated by the Barrdeen equation [J. Bardeen, Phys. Rev. Lett. 6 (1961) 57]:

$$I ( V ) = \frac{2 π e}{ℏ} {\sum }_{μ v} f ( {E}_{μ} ) ( 1 - f ( {E}_{v} + eV ) ) {\vert {M}_{μ v} \vert}^{2} δ ( {E}_{μ} - {E}_{v} )$$

Where v is the applied bias, M_{μv} is the tunneling matrix element across state μ of the tip and V of the surface, and f(E) is the Fermi function. The current therefore involves a summation across every tip and surface state.

Furthermore, Bardeen showed that the tunneling matrix element depends on the underlying tip and sample states:

$${M}_{μ v} = \frac{{ℏ}^{2}}{2 {m}_{e}} {\int }_{X} ( {Ψ}_{μ}^{\text{?}} ∇ {Ψ}_{v} - {Ψ}_{v} ∇ {Ψ}_{μ}^{\text{?}} ) \cdot {d}_{X}$$

$$\text{?} \text{indicates text missing or illegible when filed}$$

Where Ψ_{μ} and Ψᵥ is the state of the tip and donor respectively, and dχ is an element of the separation surface χ. The schematic of Bardeen's tunneling matrix element and STM image calculation is illustrated in FIG. 2.

A complication arises from the Bardeen's formula, as the current depends not only on the donor's state, and also the state of the tip's electron. In practice however, the above equation is rarely used directly, as the exact structure of STM tips is not well-known, therefore it is very challenging to find the tip state in the equation. To further simplify the equation, there are derivative rules by evaluating tunneling matrix elements for various STM tip orbitals based on Green's function representation. These rules are provided in the following table:

Chen's derivative [C. J. Chen, Phys. Rev. B 42 (1990-I) 8841.] and sum rule to evaluate matrix elements depending on tip's orbitals:

| State | M [symbol] value at [symbol] |
|---|---|
| s | ψ |
| p [z] | $\frac{\partial ψ}{\partial z}$ |
| p [x] | $\frac{\partial ψ}{\partial x}$ |
| p [y] | $\frac{\partial ψ}{\partial y}$ |
| d [zx] | $\frac{{\partial }^{2} ψ}{\partial z \partial x}$ |
| d [zy] | $\frac{{\partial }^{2} ψ}{\text{?} \partial y}$ |
| d [xy] | $\frac{{\partial }^{2} ψ}{\partial x \partial y}$ |
| $d [ {2}^{2} - \text{?} ]$ | $\frac{{\partial }^{2} ψ}{\partial {z}^{2}} \text{?}$ |
| d [x² − y²] | $\frac{{\partial }^{2} ψ}{\partial {x}^{2}} - \frac{{\partial }^{2} ψ}{\partial {y}^{2}}$ |

[symbol]

indicates data missing or illegible when filed

Chen's rule implies that when using other than the tip orbitals, the resulting STM image projects the derivative of the underlying donor wavefunction, rather than the wavefunction itself.

With Bardeen's tunneling theory and Chen's derivative and sum rules, the STM images of phosphorus donors can be computationally simulated by first evaluating the phosphorus donor wavefunction in a specified environment and applying Bardeen's and Chen's theory to calculate and plot out the distribution of current across the surface. Further details are provided in Usman et al. Nature Nanotechnology volume 11, pages 763-768, (2016).

### Atomic Placement of Subsurface Phosphorus Donors in Silicon

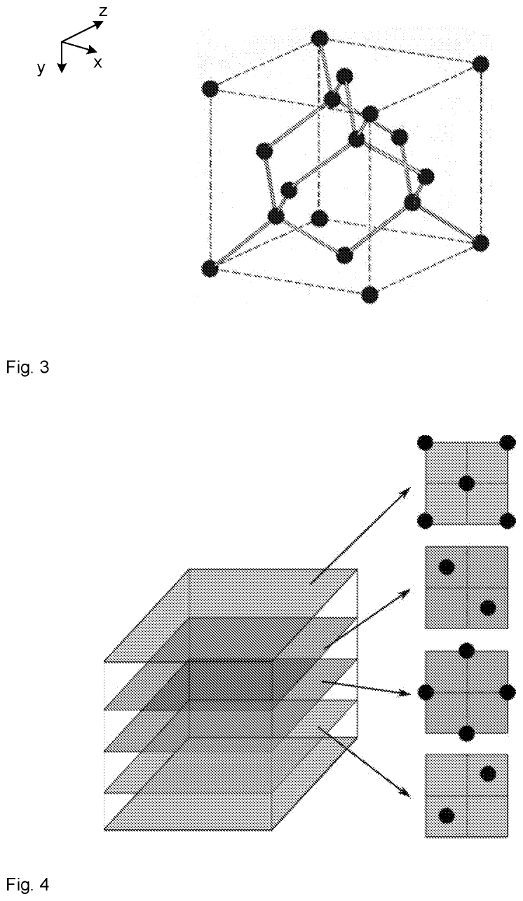

The simulation of the STM images of phosphorus donor wave functions in silicon are based on the underlying atomic structure. Silicon in its pure form is a crystalline solid with a diamond crystalline structure, meaning each silicon atom has 4 bonds with neighbouring atoms in a tetrahedral arrangement, with the diamond unit cell of silicon as shown with the xyz axes specified in FIG. 3. In this unit cell, which has a length of a₀=0.5431 nm, the atoms can be thought to be arranged in layers separated by 1/4 a₀ apart, and repeating every 4 layers, where in each layer, the atoms positions are displaced while retaining the same symmetry as shown in FIG. 4.

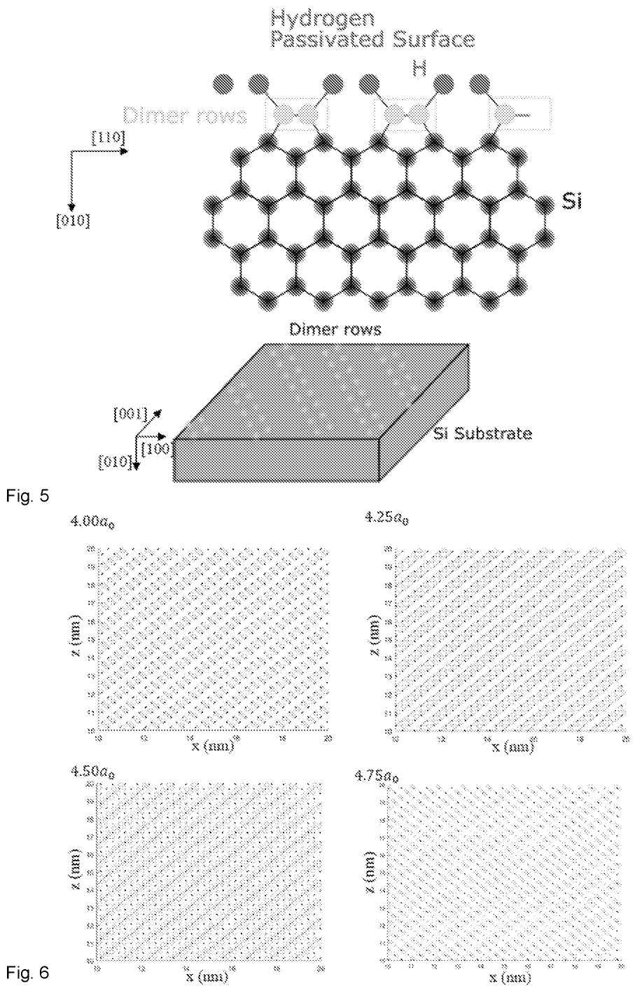

In some examples, the phosphorus atoms are fabricated close to the surface, so the crystal is not treated as extending periodically to infinity. The silicon surface in consideration is hydrogen passivated, meaning hydrogen atoms are placed on the surface to covalently bond with the dangling bonds due to the crystalline structure. The Si atoms on the surface form dimer rows where along the [110] crystal axis, instead of being evenly spaced apart, pairs of Si atoms couple together forming a 2×1 reconstructed surface, illustrated in FIG. 5.

The presence of the dimer rows may strongly influence the obtained STM images computationally which can then be exploited to increase the efficiency of the CNN via feature extraction, which will be discussed below. In one example, the layers of depth 4.00 a₀, 4.25 a₀, 4.50 a₀ and 4.75 a₀ will be considered, as along other depths, the same atomic arrangement pattern will repeat itself. Plotting out the Si atom positions and the H atoms on the [001] surface in nanometres horizontally at the considered depths is shown in FIG. 6. From the atomic position plots across each layer, two different types of positioning can be seen, with depths 4.00 a₀ and 4.25 a₀ exhibiting all the Si atoms lie on the edges of dimer rows, while at depths 4.50 a₀ and 4.75 a₀ the Si atoms alternate between lying underneath the dimer row and outside of it. The positioning of the Si atoms relative to the dimer rows impacts the symmetry of the computed STM images which will be discussed below.

The computation of the theoretical STM image is done in a four-stage process. Firstly, the P donor's electron wave function is computed by solving the sp³d⁵s* atomistic tight-binding Hamiltonian over multi-million atom domains, which includes the central-cell effects and the 2×1 surface reconstruction where the formation of dimer rows is considered. Secondly, once the donor wave functions are computed, the quantum tunneling in the vacuum region between surface and the tip at constant height mode at, for example, 0.25 nm is calculated. The computation of the donor's wave function may be performed using NEMO-3D software package. Following from the first and second stage, the images which is a two-dimensional surface plot of the tunneling current can then be computed established from Bardeen's tunneling current equation (3) and (4) based on the tip's electronic state. The final stage is then determination of the tip's electronic state which matches best the experimental image using Chen's derivative rules. Since the tip electronic state can be composed of various orbitals and the exact contribution from the orbitals in tunneling mechanism is unknown, the determination of tip state can be achieved by performing a direct image comparison of theoretical and experimental image either using rigorous pixel-by-pixel difference or manual feature-by-feature correlation. More information can be found in: Usman, M., Bocquel, J., Salfi, J., Voisin, B., Tankasala, A., Rahman, R., . . . & Hollenberg, L. C. L. Spatial metrology of dopants in silicon with exact lattice site precision. Nature nanotechnology, 11(9), 763 (2016).

Throughout this document, it is assumed that the STM tip scans along the crystal surface which is hydrogen passivated. The dimers rows in this case will be aligned along the [110] crystal axis. The depth of donor atoms is along the [001] axis. The in-plane positioning of donor atoms will be along the [001] surface at the selected depth.

### Symmetry Analysis of STM Images of Multi-Donor Systems

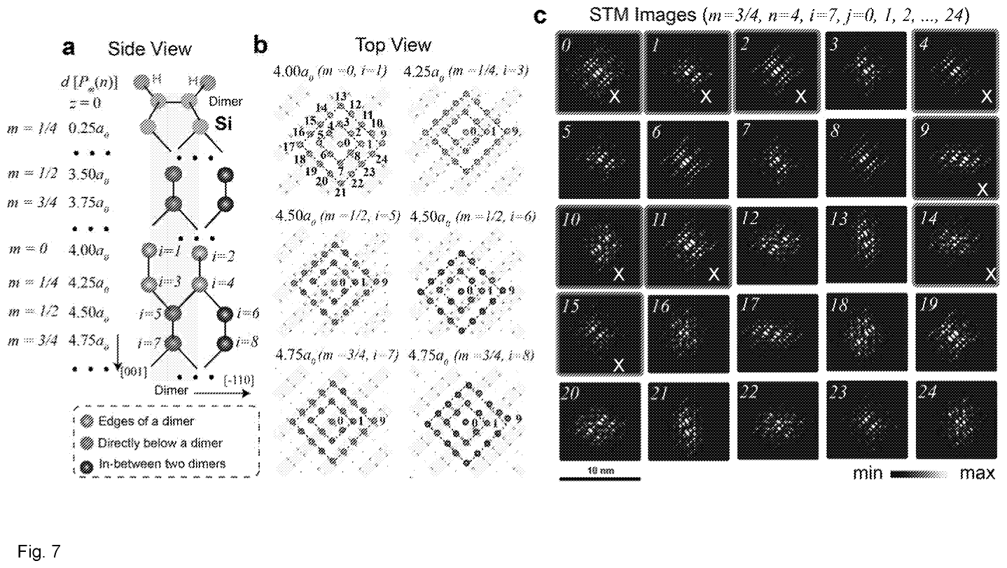

FIG. 7a exhibits the possible locations of pairs of dopant atoms in silicon crystal and our labelling convention. The plot of atoms in the [110] plane shows a small portion of the silicon crystal. The top-most layer of the atoms (shown with pink color) represents the hydrogen passivated surface and the second layer of atoms indicates the presence of dimer rows at the silicon surface. It is possible to assume the dimer row layer of atoms as the reference plane and label it as z=0 depth. The position of dopant atoms below the dimer layer along the [001] crystal direction follows a symmetry pattern, which repeats every four layers. The Si lattice planes are therefore divided into groups of four planes, where each group labelled as PGₘ and m∈{0,1/4,1/2,1/3}. The depth of each individual plane along the [001] crystal direction is now represented by d[Pₘ(n)]=(m+n)a₀, where n is the an integer whose value is 0, 1, 2, 3, . . . . Note that in this convention (m,n)=(0,0) would be the reference dimer row plane at d[P₀(0)]=0 or z=0 depth, consistent with the earlier assumption. For the purpose of demonstrating the working of the machine learning technique, one plane group (corresponding to n=4) is selected as the target depth for the dopant atoms. However, the efficiency and accuracy of the reported technique is not dependent on the selection of a plane group and any other plane group can be selected for the implementation of a quantum computer array.

By taking into account the periodicity of the dimer rows along the [−110] direction, two locations for dopant atoms can be defined per plane by i=8 m+1 and i=8 m+2. These eight locations labelled by integers i=1 to 8 in FIG. 7a repeat periodically along the in-plane directions. The relative positioning of the dopant atoms with respect to the surface dimer rows plays an important role in defining the overall symmetry of STM images. Therefore, the dopant locations are further color coded to indicate this effect. The dopant positions corresponding to m=0 and 1/4 (i=1,2,3,4) are on the edges of the dimer rows and are coloured green. One of the dopant position at m=1/2 is coloured red (i=5) which is directly below the dimer row and the other position is coloured blue (i=6) which is in-between the two dimer rows. The same applies to the positions at m=3/4 plane.

This disclosure considers qubits formed by two or more closely-spaced dopant atoms. The in-plane positioning of dopant atoms is shown in the Top View of FIG. 7b. For n=4, planes are plotted individually corresponding to n=4, selected for this example. Note that for m=0 and 1/4, there is only one value of i. This is because the position of dopant atoms on the two edges of dimer rows results in exactly same STM images, rotated by 270°. In this classification scheme, it can be assumed that one dopant atom is always at the center marked by 0. The second donor will occupy one of the locations at the boundaries of two diamonds with distance aₘ^{i,j} and 2 a₀ from the reference dopant atom. These positions are labelled anti-clockwise as 1 to 8 for the inner diamond and 9 to 24 for the outer diamond. To formalise a general labelling scheme applicable to both single and two dopant atoms, the notation I (n) is used to label the dopant atoms, where the value of j varies from 0 to 24. Here, j=0 implies a single dopant atom and 1≤j≤24 indicates that there is in addition to the first donor atom at site 0, there is now a second dopant atom at the non-zero value of j. To summarize the classification scheme, each computed STM image with-in the n=4 plane group may be distinctly labelled by m+25(i−1)+j where m represents a plane, i identifies the positioning with respect to the surface dimer rows, and j describes the individual location(s) of dopant atom(s) in the selected plane. In another example, each image is labelled by (m, n, i, j).

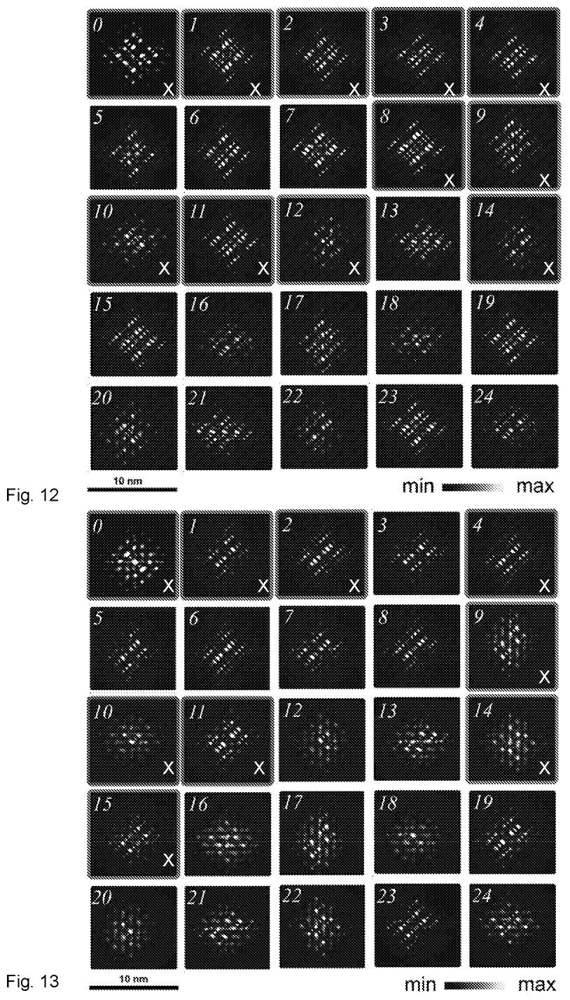

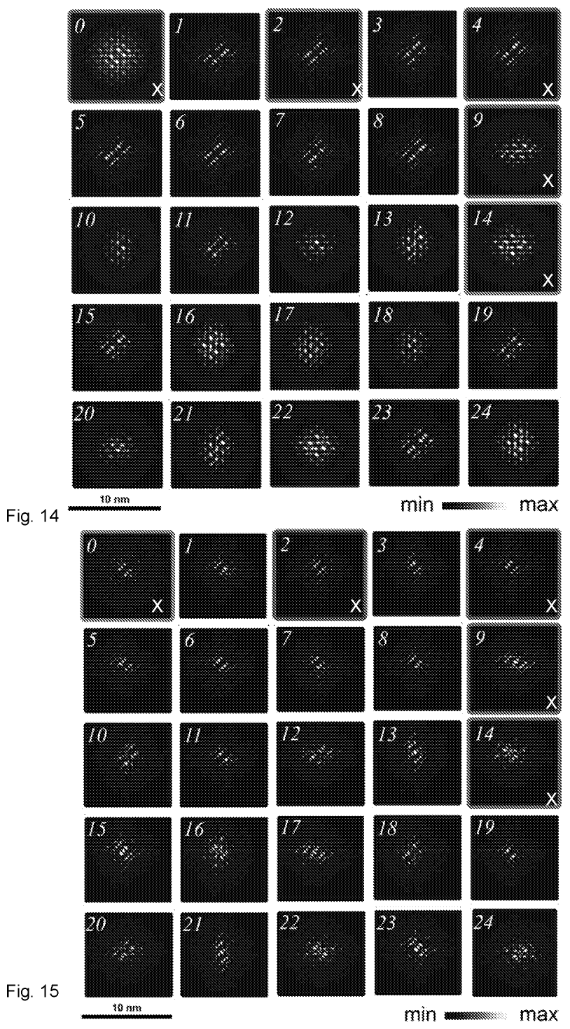

FIG. 7a, b plots the position of dopant atoms in each of the six planes corresponding to n=4. Each dopant plane offers 25 possible configurations of dopant positions, therefore in total there are 125 STM images corresponding to the dopant locations. As an example, FIG. 7c plots the STM images for one selected plane corresponding to m=3/4 and i=7. The STM images for the remaining five configurations are provided in FIGS. 11-15. The STM image for j=0 is the single dopant image, and the other images for j>0 are for the two dopant atoms. As evident from the plot of dopant positions in FIG. 7b, some of the positions are equivalent due to the symmetry of silicon crystal and their relative location with respect to dimer rows. For example, positions corresponding to j=1,3,5 and 7 are equidistant from the reference location j=0 and hence the corresponding STM images will have same symmetry and brightness of features, as clearly evident from the plot of STM images in FIG. 7c. Tables provided below describe positions which are equivalent and therefore will lead to same STM images with rotation or reflection along different axes. These STM images are indistinguishable from machine learning technique, which will assign the same image class to all these positions. In one example for m=3/4, n=4, and i=7, there are 11 possible images that can be identified distinctly by machine learning method. These are highlighted by X and will be used to train the machine learning algorithm.

In one example, qubits are formed by single phosphorus (P) atoms and a pair of P atoms that are closely spaced as shown in the FIGS. 7a and 7b. The target depths are selected as 4a₀, 4.25a₀, 4.5a₀, and 4.75a₀ from the reconstructed silicon surface (corresponding to n=4 group), where a₀ is the silicon lattice constant (0.543095 nm). However, this disclosure is applicable for larger numbers of donor atoms, such as n<10 or other limits. Based on the symmetry of donor positions with respect to the surface dimer rows, the available locations for the P donor atoms are shown in FIG. 7b. Each donor position is uniquely classified by 4 numbers (m, n, i, j), where m is the plane identifier (0, 1/4, 1/2, 3/4), n is the target plane depth group (i.e. 4 for this study), i is the atom number inside the group (1, 2, . . . , 8) along depth direction ([001]), and j is the actual location of the P atoms for given (m, n, i) and varies from 0 to 24. The j=0 corresponds to a single donor atom and j>0 indicates two phosphorus atoms, where the position of one P atom is fixed at j=0 and the second phosphorus atom is placed in one of the neighbouring positions marked by 1=1, 2, 3, . . . , 24. It is noted that this configuration is an exemplary case to demonstrate the working of this metrology. The STM based imaging technique and machine learning framework is applicable for a large number of configurations, for example where donor clusters are made up of more than 2 closely spaced atoms, or where the donor positions within the cluster also vary along the [001] direction.

FIG. 7c shows all the STM images computed for j=0, 1, 2, 3, . . . , 24 at (m, n, i)=(3/4, 4, 7). The computed STM images for (m, n, i) equal to (0, 4, 1), (1/4, 4, 3), (1/2, 4, 5), (1/2, 4, 6) and (3/4, 4, 8) are provided in FIGS. 11-15.

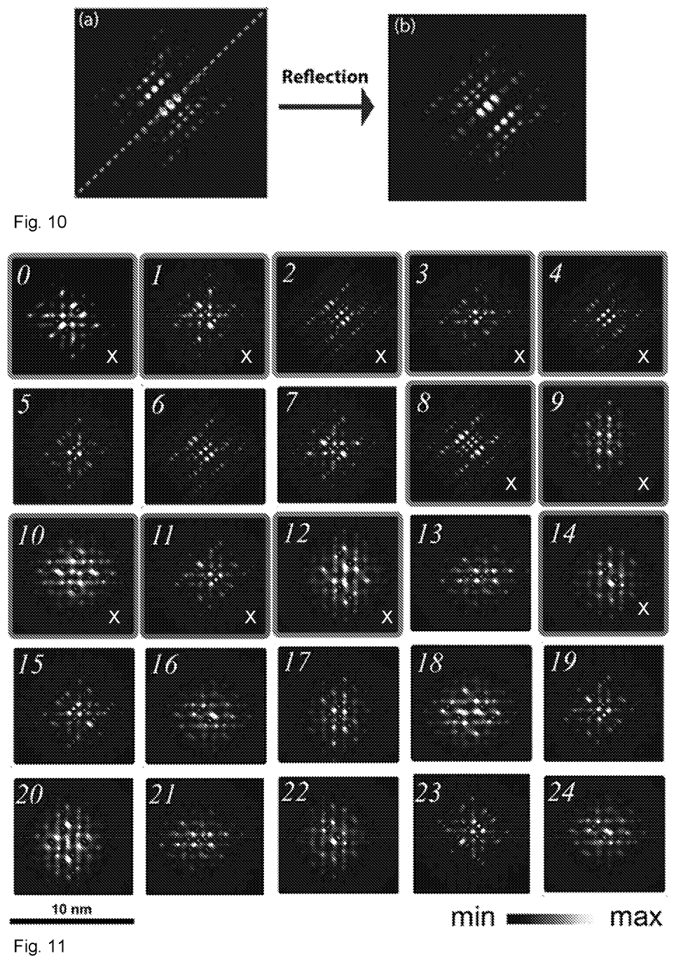

Based on the symmetry of the silicon crystal, the atomic locations for phosphorus atoms are also symmetric with respect to the centre position. Therefore, many of the STM images exhibit same symmetry and brightness of features, with rotation and/or reflection around axes parallel or perpendicular to the surface dimer rows. As an example, FIG. 10a shows an STM image for the donor position at (3/4, 4, 7, 4) along with a dotted line indicating the diagonal axis through the centre of the image parallel to the dimer row direction. When this image is reflected along the axis as shown in in part 10b, it corresponds to the donor position at (3/4, 4, 7, 8). Therefore, these two donor positions ((3/4, 4, 7, 4) & (3/4, 4, 7, 8)) are symmetrical in the silicon crystal and lead to STM images with a similar feature distribution. In FIGS. 7c, 11, 12, 13, 14 and 15 the unique STM images are highlighted by “X” marking and the other STM images are symmetry identical of these images.

The machine learning framework will identify only one donor position for both positions in FIG. 10. Such positions can be classified into the same image class. By carefully analysing the symmetry of all computed STM images, they can be grouped in the same classes when they exhibit same feature maps within rotation and/or reflection operation. The tables below provide classification of the STM images in unique image classes and also describe the relationship (symmetry, rotation and/or reflection) between the images within the same class. Based on this classification, a total of fifty classes of unique STM images can be identified. The machine learning algorithm will process a test image and return a probability distribution consisting of fifty numbers, where each number will be the probability of that test image being in one of the fifty classes. The image will be recognized and characterized based on the highest probability value. In other words, applying the trained machine learning model results in an output that comprises fifty probabilities and the location of the donor atoms is determined by obtaining the position associated with the highest probability value.

TABLE 1
STM images for (3/4, 4, 7, j) positions for two-donor systems
are sorted in classes of unique images, where each class
is defined by (m, n, i, min(j)) where min(j) is the minimum
value of j in that class. There are in total nine classes.

| | | Relationship of images |
|---|---|---|
| (m, n, i, min(j)) | STM images (j) | within the class |
| (3/4, 4, 7, 0) | 0 | Single donor image. |
| (3/4, 4, 7, 1) | 1, 3, 5, 7 | Reflection and/or rotation |
| | | along axes parallel or normal |
| | | to dimer rows. |
| (3/4, 4, 7, 2) | 2, 6 | Symmetrical positions lead to |
| | | same image features. |
| (3/4, 4, 7, 4) | 4, 8 | Reflection around axis parallel |
| | | and/or normal to dimer rows. |
| (3/4, 4, 7, 9) | 9, 13, 17, 21 | Reflection and/or rotation |
| | | along axes parallel or normal |
| | | to dimer rows. |
| (3/4, 4, 7, 10) | 10, 12, 18, 20 | Reflection and/or rotation |
| | | along axes parallel or normal |
| | | to dimer rows. |
| (3/4, 4, 7, 11) | 11, 19 | Symmetrical positions lead |
| | | to same image features. |
| (3/4, 4, 7, 14) | 14, 16, 22, 24 | Reflection and/or rotation |
| | | along axes parallel or normal |
| | | to dimer rows. |
| (3/4, 4, 7, 15) | 15, 23 | Symmetrical positions lead to |
| | | same image features. |

TABLE 2
STM images for (1/2, 4, 5, j) positions are sorted in
classes of unique images, where each class is defined
by (m, n, i, min(j)) where min(j) is the minimum value
of j in that class. There are in total nine classes.

| | | Relationship of images |
|---|---|---|
| (m, n, i, min(j)) | STM images (j) | within the class |
| (1/2, 4, 5, 0) | 0 | Single donor image. |
| (1/2, 4, 5, 1) | 1, 3, 5, 7 | Reflection and/or rotation |
| | | along axes parallel or normal |
| | | to dimer rows. |
| (1/2, 4, 5, 2) | 2, 6 | Symmetrical positions lead to |
| | | same image features. |
| (1/2, 4, 5, 4) | 4, 8 | Reflection around axis parallel |
| | | and/or normal to dimer rows. |
| (1/2, 4, 5, 9) | 9, 13, 17, 21 | Reflection and/or rotation |
| | | along axes parallel or normal |
| | | to dimer rows. |
| (1/2, 4, 5, 10) | 10, 12, 18, 20 | Reflection and/or rotation |
| | | along axes parallel or normal |
| | | to dimer rows. |
| (1/2, 4, 5, 11) | 11, 19 | Symmetrical positions lead to |
| | | same image features. |
| (1/2, 4, 5, 14) | 14, 16, 22, 24 | Reflection and/or rotation |
| | | along axes parallel or normal |
| | | to dimer rows. |
| (1/2, 4, 5, 15) | 15, 23 | Symmetrical positions lead to |
| | | same image features. |

TABLE 3
STM images for (0, 4, 1, j) positions are sorted in classes
of unique images, where each class is defined by (m,
n, i, min(j)) where min(j) is the minimum value of j
in that class. There are in total eleven classes.

| | | Relationship of images |
|---|---|---|
| (m, n, i, min(j)) | STM images (j) | within the class |
| (0, 4, 1, 0) | 0 | Single donor image. |
| (0, 4, 1, 1) | 1, 7 | Reflection and/or rotation |
| | | along axes parallel or normal |
| | | to dimer rows. |
| (0, 4, 1, 2) | 2, 6 | Symmetrical positions lead to |
| | | same image features. |
| (0, 4, 1, 3) | 3, 5 | Reflection around axis parallel |
| | | and/or normal to dimer rows. |
| (0, 4, 1, 4) | 4 | Distinct image without any match. |
| (0, 4, 1, 8) | 8 | Distinct image without any match. |
| (0, 4, 1, 9) | 9, 13, 17, 21 | Reflection and/or rotation |
| | | along axes parallel or normal |
| | | to dimer rows. |
| (0, 4, 1, 10) | 10, 20 | Reflection and/or rotation |
| | | along axes parallel or normal |
| | | to dimer rows. |
| (0, 4, 1, 11) | 11, 15, 19, 23 | Reflection and/or rotation |
| | | along axes parallel or normal |
| | | to dimer rows. |
| (0, 4, 1, 12) | 12, 18 | Reflection and/or rotation |
| | | along axes parallel or normal |
| | | to dimer rows. |
| (0, 4, 1, 14) | 14, 16, 22, 24 | Reflection and/or rotation |
| | | along axes parallel or normal |
| | | to dimer rows. |

TABLE 4
STM images for (1/4, 4, 3, j) positions are sorted in
classes of unique images, where each class is defined
by (m, n, i, min(j)) where min(j) is the minimum value
of j in that class. There are in total eleven classes.

| | | Relationship of images |
|---|---|---|
| (m, n, i, min(j)) | STM images (j) | within the class |
| (1/4, 4, 3, 0) | 0 | Single donor image. |
| (1/4, 4, 3, 1) | 1, 7 | Reflection and/or rotation |
| | | along axes parallel or normal |
| | | to dimer rows. |
| (1/4, 4, 3, 2) | 2, 6 | Symmetrical positions lead to |
| | | same image features. |
| (1/4, 4, 3, 3) | 3, 5 | Reflection around axis parallel |
| | | and/or normal to dimer rows. |
| (1/4, 4, 3, 4) | 4 | Distinct image without any match. |
| (1/4, 4, 3, 8) | 8 | Distinct image without any match. |
| (1/4, 4, 3, 9) | 9, 13, 17, 21 | Reflection and/or rotation |
| | | along axes parallel or normal |
| | | to dimer rows. |
| (1/4, 4, 3, 10) | 10, 20 | Reflection and/or rotation |
| | | along axes parallel or normal |
| | | to dimer rows. |
| (1/4, 4, 3, 11) | 11, 15, 19, 23 | Reflection and/or rotation |
| | | along axes parallel or normal |
| | | to dimer rows. |
| (1/4, 4, 3, 12) | 12, 18 | Reflection and/or rotation |
| | | along axes parallel or normal |
| | | to dimer rows. |
| (1/4, 4, 3, 14) | 14, 16, 22, 24 | Reflection and/or rotation |
| | | along axes parallel or normal |
| | | to dimer rows. |

TABLE 5
STM images for (1/2, 4, 6, j) positions are sorted in classes
of unique images, where each class is defined by (m, n, i, min(j))
and min(j) is the minimum value of j in that class. Note that
in this case, some of the classes consists images which are same
as in classes (1/2, 4, 5, j) and therefore are not considered
unique. There are in total five classes of unique images.

| | | Relationship of images |
|---|---|---|
| (m, n, i, min(j)) | STM images (j) | within the class |
| (1/2, 4, 6, 0) | 0 | Single donor image. |
| (1/2, 4, 6, 1) = | 1, 3, 5, 7 | These are not distinct donor |
| (1/2, 4, 5, 1) | | positions and are same as the |
| | | corresponding positions in |
| | | (1/2, 4, 5, 1) class. |
| (1/2, 4, 6, 2) | 2, 6 | Symmetrical positions lead to |
| | | same image features. |
| (1/2, 4, 6, 4) | 4, 8 | Reflection around axis parallel |
| | | and/or normal to dimer rows. |
| (1/2, 4, 6, 9) | 9, 13, 17, 21 | Reflection and/or rotation |
| | | along axes parallel or normal |
| | | to dimer rows. |
| (1/2, 4, 6, 10) = | 10, 12, 18, 20 | These are not distinct donor |
| (1/2, 4, 5, 10) | | positions and are same as the |
| | | corresponding positions in |
| | | (1/2, 4, 5, 10) class. |
| (1/2, 4, 6, 11) = | 11, 19 | These are not distinct donor |
| (1/2, 4, 5, 15) | | positions and are same as the |
| | | corresponding positions in |
| | | (1/2, 4, 5, 15) class. |
| (1/2, 4, 6, 14) | 14, 16, 22, 24 | Reflection and/or rotation |
| | | along axes parallel or normal |
| | | to dimer rows. |
| (1/2, 4, 6, 15) = | 15, 23 | These are not distinct donor |
| (1/2, 4, 5, 11) | | positions and are same as the |
| | | corresponding positions in |
| | | (1/2, 4, 5, 11) class. |

TABLE 6
STM images for (3/4, 4, 8, j) positions are sorted in classes
of unique images, where each class is defined by (m, n, i, min(j))
and min(j) is the minimum value of j in that class. Note that
in this case, some of the classes consists images which are same
as in classes (3/4, 4, 7, j) and therefore are not considered
unique. There are in total five classes of unique images.

| | | Relationship of images |
|---|---|---|
| (m, n, i, min(j)) | STM images (j) | within the class |
| (3/4, 4, 8, 0) | 0 | Single donor image. |
| (3/4, 4, 8, 1) = | 1, 3, 5, 7 | These are not distinct donor |
| (3/4, 4, 7, 1) | | positions and are same as the |
| | | corresponding positions in |
| | | (3/4, 4, 7, 1) class. |
| (3/4, 4, 8, 2) | 2, 6 | Symmetrical positions lead to |
| | | same image features. |
| (3/4, 4, 8, 4) | 4, 8 | Reflection around axis parallel |
| | | and/or normal to dimer rows. |
| (3/4, 4, 8, 9) | 9, 13, 17, 21 | Reflection and/or rotation |
| | | along axes parallel or normal |
| | | to dimer rows. |
| (3/4, 4, 8, 10) = | 10, 12, 18, 20 | These are not distinct donor |
| (3/4, 4, 7, 10) | | positions and are same as the |
| | | corresponding positions in |
| | | (3/4, 4, 7, 10) class. |
| (3/4, 4, 8, 11) = | 11, 19 | These are not distinct donor |
| (3/4, 4, 7, 15) | | positions and are same as the |
| | | corresponding positions in |
| | | (3/4, 4, 7, 10) class. |
| (3/4, 4, 8, 14) | 14, 16, 22, 24 | Reflection and/or rotation |
| | | along axes parallel or normal |
| | | to dimer rows. |
| (3/4, 4, 8, 15) = | 15, 23 | These are not distinct donor |
| (3/4, 4, 7, 11) | | positions and are same as the |
| | | corresponding positions in |
| | | (3/4, 4, 7, 11) class. |

### Application of Noise

The computed STM images demonstrate a perfect symmetry and sharp bright features. In the realistic experimental measurements the STM images exhibit blurriness and asymmetry in the feature brightness. Although the theoretically computed STM images have been shown in the literature to capture the measured features with an unprecedented accuracy, the resiliency of the machine learning framework can be tested against the presence of noise levels commensurate with the previously published experimental measurements. During the training part of the machine learning framework, ideal STM images (ideal STM images are defined as computed STM images without any noise) and STM images with the asymmetrical feature noise (also called here as planar noise) and blurred feature noise (also called here as blurring noise) levels can be used. The trained machine learning algorithms is then applied to identify dopant configurations when both, the asymmetrical features and blurriness of feature brightness, noises are present.

### Planar Noise:

To capture the effect of asymmetry in brightness features, one method of simulating planar noise may involve computing a two-dimensional function:

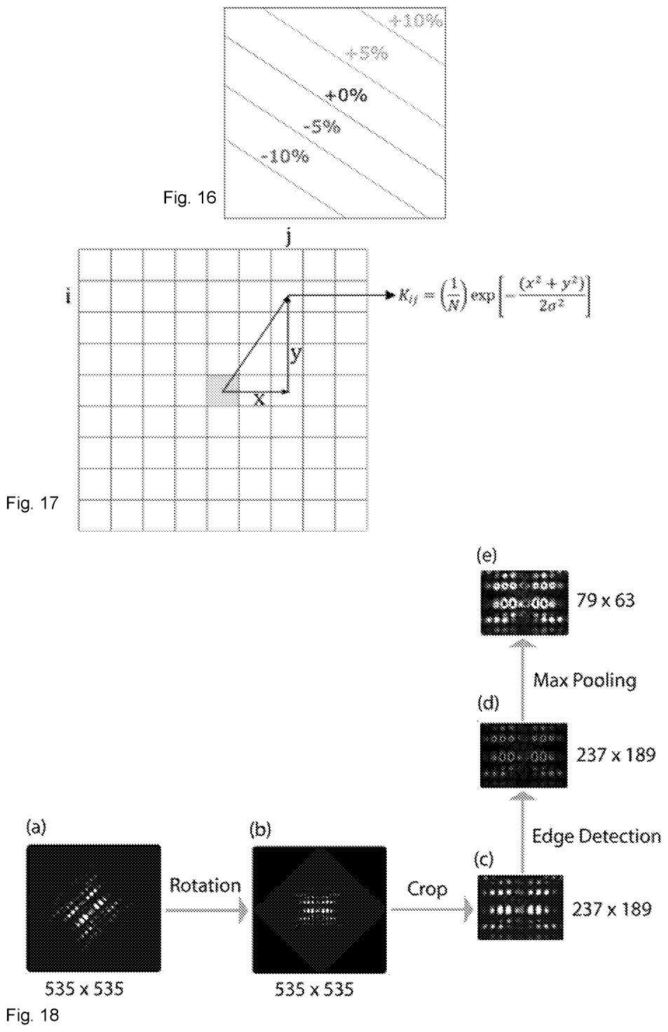

(x,y)=1+N_{z}+(x−x₀)+N_{y}(y−y₀)

Where Nₓ, N_{y} and N_{z} are independently randomly generated from the Gaussian distribution with μ=0 and σ_{P} is set to various noise levels. Here, x₀ and y₀ are arbitrarily chosen to be close to the centre of the image. An example sample of the contour of such a plane created is as shown in FIG. 16.

The resulting STM image including the planar noise can then be simulated by using:

Iₙₒᵢₛₑ(x,y)=I_{ideal}(x,y)×N(x,y)

Where Iₙₒᵢₛₑ(x,y) and I_{ideal}(x,y) are the computed STM images with planar noise and ideal STM images, respectively.

Since the training set for the neural network uses a large number of STM images, the planar noise is included in the training set by varying its magnitude randomly between 0.01 and 0.3. A limit of 0.3 is chosen as an STM image with σ_{P}>0.3 will be heavily distorted and is unlikely to be identified by machine learning algorithm. To create a reasonable size for the training and test set, for each σ_{P} value, 100 and 20 independent images are generated for the training and test set, respectively, giving a total of 2000 and 400 images for the training and test set for each class, respectively. By this method for fifty classes of unique STM images, in total 100,000 training images and 20,000 test images are used.

### Blurring Noise:

Another difference between the theoretical and experimental images may be due to blurriness effect. The theoretical images exhibit sharp well-defined features, whereas the experimental image as published in the literature typically show blurred features. Blurring may be defined as the case where an image is not well-focus, and each pixel instead of being represented by a single sharp value is ‘mixed’ with neighbouring pixels. It could also define the case when the features appear larger than the size based on the computation. The blurring of a sharp image can be simulated via a process of Gaussian blurring, in which the image is convoluted with a kernel that represents a 2D Gaussian distribution with the peak at the centre:

$${K}_{ij} = ( \frac{1}{N} ) exp [ - \frac{( {x}^{2} + {y}^{2} )}{2 {σ}_{B}^{2}} ]$$

Where x and y represents the horizontal and vertical displacement of an element from the centre of the kernel respectively, σ_{B} represents the level of blurriness in terms of pixels, and N is the normalization factor to ensure the sum of all elements in the kernel add up to one, such that the resulting blurred image is neither brighter nor darker compared to the original image. The evaluation of the Gaussian blurring kernel is illustrated in FIG. 17. The table below shows the kernel values with σ_{B}=2:

| | | | | | | | | |
|---|---|---|---|---|---|---|---|---|
| 7.6345e−04 | 0.0018 | 0.0034 | 0.0050 | 0.0056 | 0.0050 | 0.0034 | 0.0018 | 7.6345e−04 |
| 0.0018 | 0.0044 | 0.0082 | 0.0119 | 0.0135 | 0.0119 | 0.0082 | 0.0044 | 0.0018 |
| 0.0034 | 0.0082 | 0.0153 | 0.0223 | 0.0253 | 0.0223 | 0.0153 | 0.0082 | 0.0034 |
| 0.0050 | 0.0119 | 0.0223 | 0.0325 | 0.0368 | 0.0325 | 0.0223 | 0.0119 | 0.0050 |
| 0.0056 | 0.0135 | 0.0253 | 0.0368 | 0.0417 | 0.0368 | 0.0253 | 0.0135 | 0.0056 |
| 0.0050 | 0.0119 | 0.0223 | 0.0325 | 0.0368 | 0.0325 | 0.0223 | 0.0119 | 0.0050 |
| 0.0034 | 0.0082 | 0.0153 | 0.0223 | 0.0253 | 0.0223 | 0.0153 | 0.0082 | 0.0034 |
| 0.0018 | 0.0044 | 0.0082 | 0.0119 | 0.0135 | 0.0119 | 0.0082 | 0.0044 | 0.0018 |
| 7.6345e−04 | 0.0018 | 0.0034 | 0.0050 | 0.0056 | 0.0050 | 0.0034 | 0.0018 | 7.6345e−04 |

The blurring can be made randomized by first making the blurring kernel elliptical, and rotated at a random angle:

$${K}_{ij} = ( \frac{1}{N} ) exp [ - \frac{{( x cos θ + y sin θ )}^{2}}{{σ}_{1}^{2}} - \frac{{( y cos θ - x sin θ )}^{2}}{{σ}_{2}^{2}} ]$$

Where σ₁ and σ₂ are independently drawn from the Gaussian distribution of N(0, σ_{B}), which when squared results in a χ² distribution with 1 degree of freedom, and θ is drawn from a uniform distribution from [0, 2π] which represents rotation of ellipse. In one example of the kernels of the randomized Gaussian blurring, σ_{B} is chosen to be 3. In one example, experimental images demonstrate a blurriness level represented by σ_{B}<3.0. It is mentioned here that in the preparation of training data set, only planar noise is considered. However, the test images may include both planar and blurring noise with randomly selected strengths commensurate with the typical experimental measurements published in the literature.

### Image Reduction and Pre-Processing

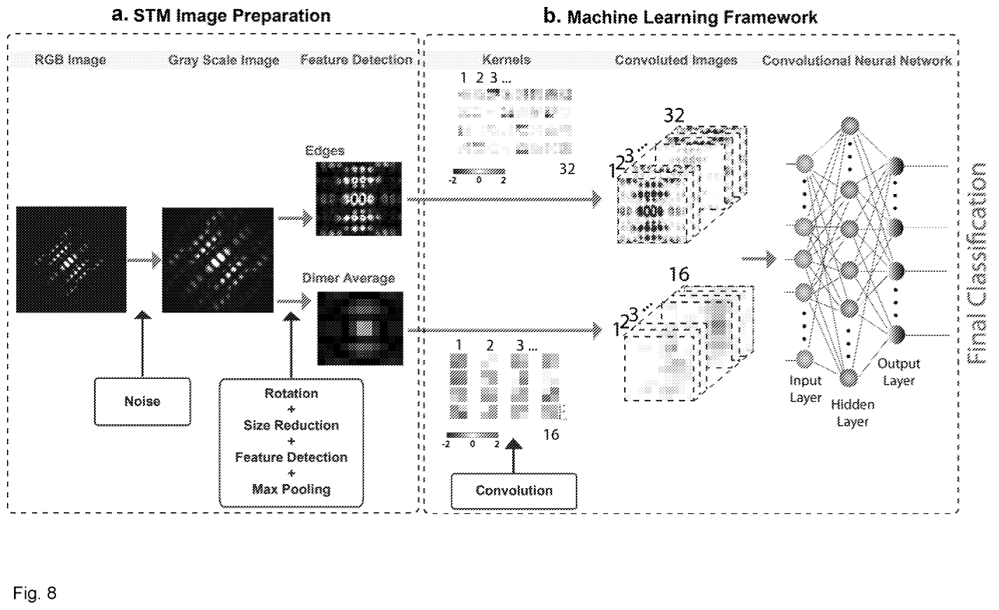

The computed STM images from the dopant wave functions are typically spanned over 8×8 nm² area, consisting of about 535×535 pixels. Furthermore, each coloured pixel is represented in RGB format with three integers each varying from 0 to 255. The resulting overall size of an STM image require large matrix dimensions, which would be computationally expensive to store and process several thousand images used for the training of the machine learning framework. To reduce the burden of computational cost, each STM image is pre-processed. The pre-processing steps are shown in FIG. 8 for an exemplary image. First, an STM image is converted from coloured RGB format to grayscale format, in which each pixel is represented by only two numbers describing either bright or dark colour. This step drastically reduces the storage requirements for an image, while preserving the critical information, such as the size and relative brightness of the features. It is noted that each STM image consists of large black area around the central part consisting of bright features. This black area represents the negligible amplitude of tunnelling current and therefore does not contain any useful information. In the second step, each image is rotated by 90 degrees clockwise and cut the dark area around the images. The typical image size is now 44319 pixels.

The information about image symmetry is present in the bright features. Each image consists of twenty to thirty bright features which distinctly describe the corresponding position(s) of dopant atom(s). To further reduce the size of image, the process focusses on the bright features and applies two techniques to extract relevant information while preserving the overall information about the donor locations. The first method is labelled here as edge detection. This technique extracts the boundaries or edges of the features. The image is then sub-sampled or max-pooled to obtain a final image consisting of 4977 gray-scale pixels. The second method is labelled as feature averaging. The technique is based on the fact that each bright feature is present on one dimer pair on the silicon surface. Therefore instead of using the complete information inside the bright features, an average is calculated over all the pixels per dimer pair, which drastically reduces the overall size of image. After averaging over dimer pairs, the image size is only 110 pixels. The final image in this case consists of significantly less pixels than the original image. These processed images are then supplied to a convolutional neural network (CNN) for training and identification.

### Edge Detection Reduction

FIG. 18 shows an example procedure applied for STM image reduction in case of the edge detection scheme. As an example, an STM image corresponding to (1/2,4,8,5) position is selected and converted to grey-scale as shown in part (a). It can be noted that the bright features are present around the centre region and a large portion of the image is dark, indicating negligible tunnelling current. The overall size of the image can be reduced by first rotating the image clockwise by 45° as shown in (b) and then cropping the dark pixels in the image as exhibited in (c). This is done by setting a threshold value for tunnelling current, below which the image pixels are removed. After these steps, the size of the image is reduced from 535×535 pixels to 237×189 pixels.

It is further noted that the information is stored in the size and shape of the bright features, therefore extraction of feature edges will preserve the information about the underpinning donor positions. This step is performed by a mathematical convolution function with the following kernel:

$${K}_{edge} = [ \begin{matrix}- 1 & - 1 & - 1 \\ - 1 & 8 & - 1 \\ - 1 & - 1 & - 1\end{matrix} ]$$

The convoluted image is plotted in (d). Finally, the size of image can be further reduced by applying a sub-sampling for max-pooling function. This function divides the pixel map into smaller sections and for each section, the maximum value is selected. The image after the application of 2×2 max-pooling function is shown in (e) which consists of 79×63 pixels. The overall reduction of STM image size from 535×535 pixels to 79×63 pixels significantly improves the computational efficiency of neural network in both training and testing phases.

### STM Image Processing for Feature Averaging Reduction

The STM image reduction procedure for feature averaging scheme is shown in FIG. 19 for an image corresponding to the position (0,4,1,8). The first two steps are same as previously described and are shown in parts (a) and (b). After rotation and cropping of the STM image, a feature averaging procedure is applied. The image features which contain the overall information about the underpinning donor positions are present on atomic positions at the dimer sites. As each feature is distinct in an image and the arrangement of features is also unique between different donor positions, it is possible to significantly reduce the size of STM image by only persevering average brightness of each feature. This is done by first overlaying the image with dimer atom positions as shown in part (c). There are 11×10 atom positions which cover all of the bright features. Since from the inspection of STM images, the bright features are around the dimer rows, these features can be extracted by simply finding the average brightness by averaging the current reading around each dimer rows where the P donor pairs are placed. This reduces the STM image to 11×10 pixel values, where each pixel represents the average brightness of each dimer atom.

$${F}_{ij} = \frac{1}{π {R}^{2}} {\int }_{\vert r - {r}_{ij} \vert < R} I ( x , y ) dA$$

Where Fᵢⱼ is the average current reading around dimer rᵢⱼ about a specified radius R. For R=0.05 nm, the evaluation of the average feature image of a sample image is illustrated in part (d).

### Training of a Convolutional Neural Network

The processed STM images are used to train a convolutional neural network (CNN). As described before, only planar noise is applied to STM images during the training of CNN but other noise may be included (such as random noise). The STM images including blurring noise can be later used to test the fidelity of the CNN to accurately determine the position(s) of the dopant atom(s). The training of a CNN uses large number of images. For this purpose, the method not only uses ideal STM images corresponding to n=4, but each image is also applied several different levels of planar noise to expand the training dataset. This creates 2000 images for each class, resulting in tatal of 100,000 images in the training set for all fifty classes.

Each image in the training dataset, after the processing of FIG. 8a, is passed through the convolution layer before training a CNN. For the edge detected images, the feature map images are scaled to 48×48 pixels, which form the input to the CNN. The CNN consist of a convolutional layer with 32 3 λ3 kernels along with 2×2 max pooling, followed by a hidden layer of 256 rectified linear units (ReLu) activated neurons. Training with 30 epochs yields an accuracy of 99.5% on the test set consisting of ideal images. On the other hand, for average features, no scaling of the image needed, with a hidden layer of 64 ReLu activated neurons, and training with 20 epochs, an accuracy of 100% is achieved on the test set consisting of ideal images. On both feature extraction methods, a near perfect learning is achieved. The number of neurons (256 and 64 in the two cases described above) are chosen by testing out various numbers, and a sufficiently low number of neurons that will maintain the near perfect learning is chosen. The implementation of the CNN is performed by using Keras, utilizing TensorFlow as the backend. However the CNN implementation is not restricted to TesnorFlow program but may be implemented by using other open source platforms such as Neon, OpenDL, or Torch.

Mainly the training settings can be set to default, such as learning rate being set to 0.01. For the edge detection case described above, the processed STM images including planar noise to train the CNN. The CNN may consist of a convolutional layer with 32, 3×3 kernels along with 2×2 max-pooling, followed by a hidden layer of 256 rectified linear unit (ReLu) activated neurons as they offer better learning rate for the CNN. Training with 30 epochs yielded an accuracy of 99.5% or above for a test set consisting of STM images without the addition of noise.

In the case of feature averaging scheme (described above), the CNN consisted of a hidden layer of 64 ReLu activated neurons. The training with 20 epochs led to an accuracy of 100% for a test set consisting of STM images without the addition of noise. Therefore, we report that for the test STM images without the introduction of noise, a near perfect learning of the training images is achieved on the test images. The number of neurons is chosen by testing out various numbers, and the least number of neurons that will maintain the near perfect learning is selected.

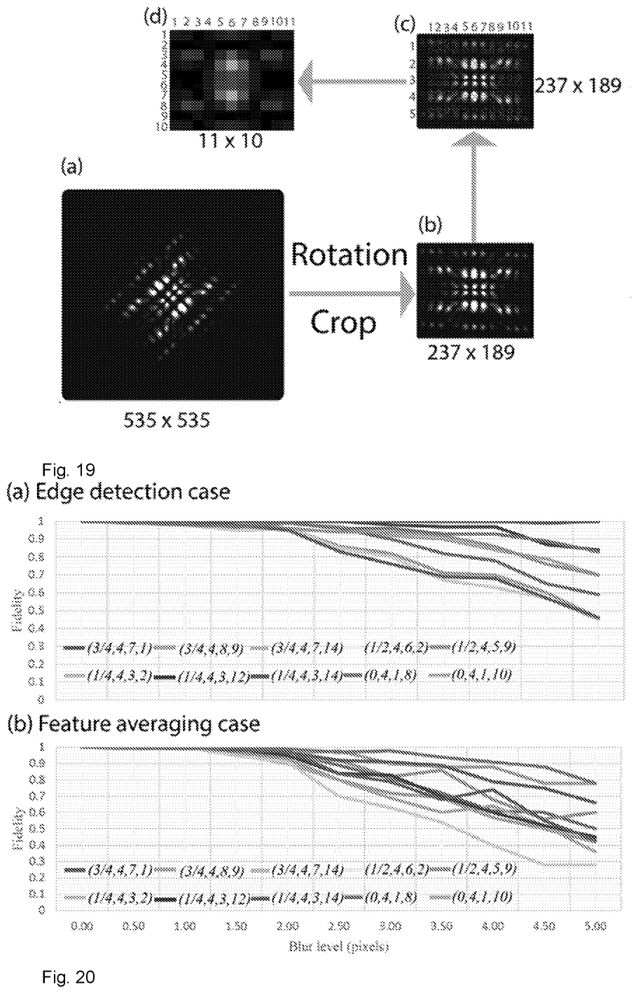

As the measured STM images exhibit some level of planar and blurring noise, so in the next phase, we performed testing of the trained CNN for the images containing random levels of noise. First, we evaluated the CNN fidelities with the introduction of blurring noise only for both edge detection and feature averaging cases. For this purpose, 10 arbitrary groups of STM images (defined in the tables 1, 2, and 3) are chosen, with 100 samples of each blurring level ranging from σ_{B}=0.5 to σ_{B}=5.0 at an increment of 0.5. The accuracy is measured based on the proportion of correct predictions out of the 100 samples. For each test image, the CNN returns a set of probability values indicating the probability of that image being in one of the particular class. FIG. 20 shows the graphs of fidelities as a function of blur level for each of the test class. From these results, we infer that our CNN identifies donor positions with 100% accuracy for blurring noise levels below 1.0. As the noise strength increases, the accuracy of the CNN decreases. It is also noted that the decrease in identification accuracy is dependent on the STM image class.

### Qubit Characterisation Fidelities

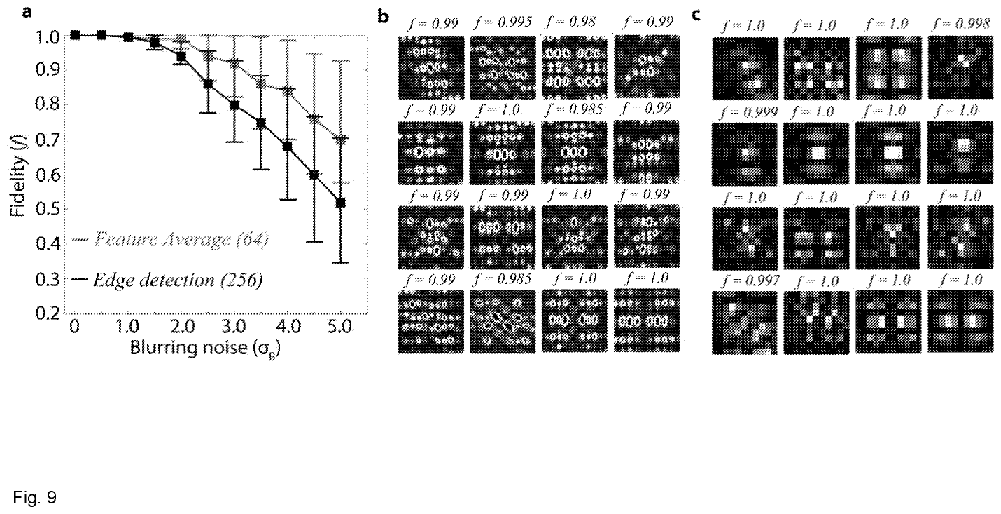

To perform the comparison between two image processing methods, we plot the average fidelities as a function of blurring noise along with error bars based on sample standard deviation in FIG. 9a. This plot clearly shows that overall the feature averaging method exhibits a better fidelity compared to the edge detection regardless of the number of perceptrons is in the hidden layer. This is also accompanied with significantly higher computational efficiency. Based on 100,000 training images and 20,000 test images, we find that the feature averaging method takes about 30 minutes time, compared to the 3 hours' time frame for edge detection case on an average desktop machine. Overall, we conclude that the feature averaging method is a better choice for training a CNN capable of spatial metrology of donor-based qubits in silicon.

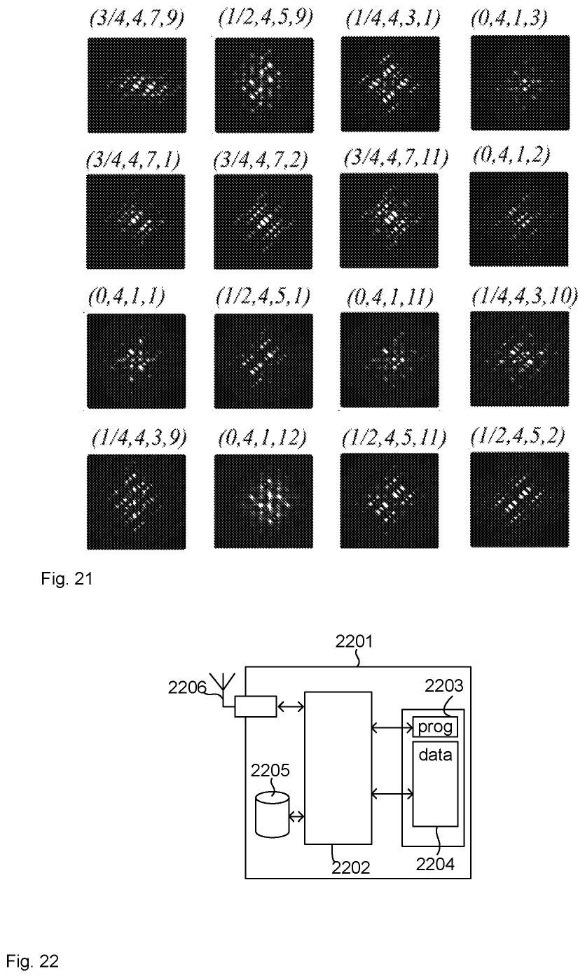

To test the fidelities of the trained CNN for STM images perturbed by both planar and blurring noise, we select a set of 16 images plotted in FIG. 21. Each image is processed according to both edge detection and feature averaging schemes and perturbed with randomly selected strengths of noise levels in the range defined as follows: 0<σ_{B}<2.0 and 0<σ_{P}<0.3. After processing, the final test images are plotted in FIG. 9b and FIG. 9c. In each case, we have also mentioned the fidelity from the CNN to accurately determine the corresponding donor positions. In all cases, our results show a fidelity which is sufficient to perform robust qubit characterization.

In another example, it is possible no test the accuracy of trained machine learning framework by computing STM images for an exemplary two-dimensional quantum computer array, consisting of 10,000 qubits. Each qubit may be randomly selected to be at one of the four planes in the =4 plane group. Furthermore, the qubits may be comprised of single or two phosphorus dopant atoms based on a random value for, selected between 0 and 24. The 10,000 images may be pre-processed to reduce their size and perturbed by adding both asymmetric feature brightness and blurriness of features. The images may then be processed to obtain two separate sets based on edge detection and average over dimer locations. The images may be passed to the machine learning framework, which identified the corresponding location(s) of the dopant atom(s) for both sets of images. This indicates a success fidelity of above 99%.

### Summary and Outlook

In summary, this disclosure provides a method for autonomous determination of dopant impurity clusters in silicon suitable for the charactrisation of large-scale arrays of such systems. The input to the framework are STM images of electron wave functions confined on single dopants or small clusters of closely-spaced dopants in the overall array. The images are processed to reduce computational burden and useful information is extracted by applying two methods, namely feature edge detection and average feature brightness. A convolutional neural network (CNN) is trained to recognise STM images and pinpoint the corresponding dopant atom position(s) with exact lattice site precision, which is a critical challenge towards the design of high-fidelity two-qubit quantum gates. The technique is suitable for arrays fabricated via STM lithography or ion-implantation, and the STM images of dopant wave functions are measured via low-temperature tunnelling of single electron. The high-through aspect of the technique is important for the characterisation of large-scale error-corrected architectures consisting of millions of qubits, where characterisation based on human interaction is impractical.

This disclosure may support a machine learning based design of a complete error-corrected surface code architecture. Characterisation of donor qubit systems based on machine learning techniques described here can be applied to provide crucial input for the design of error-correction schemes. The framework can be reprogrammed to start with STM images of a 2D array of donor qubit systems, where each qubit is formed by positioning of dopant(s). The identification of the exact dopant number and locations will map to interactions between the qubits, and lead to design of two qubit operations.

### Tight-Binding Wave Function Calculations

The computation of phosphorus dopant wave functions is performed by solving an atomistic sp³ d⁵ s*tight-binding Hamiltonian as in T. B. Boykin, G. Klimeck, F. Oyafuso, Phys. Rev. B 69 (2004) 115201. The P donor atom is placed in a large silicon box consisting of four million atoms. The confining potential on P atom is represented by a comprehensive description of central-cell effects, which include non-static dielectric screening of donor potential as in M. Usman, R. Rahman, J. Sal, J. Bocquel, B. Voisin, S. Rogge, G. Klimeck, L. C. L. Hollenberg, J. Phys.: Cond. Matt. 27 (2015) 154207.

The value of U₀ is adjusted to empirically fit the binding energies of is manifold of states as in M. Usman, C. D. Hill, R. Rahman, G. Klimeck, M. Y. Simmons, S. Rogge, L. C. L. Hollenberg, Phys. Rev. B 91 (2015) 245209. The calculation of wave function also included the effect of 2×1 surface reconstruction, leading to the formation of dimer rows on z=0 surface as in M. Usman, J. Bocquel, J. Sal, B. Voisin, A. Tankasala, R. Rahman, M. Y. Simmons, S. Rogge, L. Hollenberg, Nature Nanotechnology 11 (2016) 763. The boundary conditions for the silicon box are selected as closed, with dangling bond energies shifted by large values to exclude their effect in the working range of energy as in S. Lee, et al., Phys. Rev. B 69 (2004) 045316. The theoretical calculations were performed using the NEMO-3D framework according to G. Klimeck, S. Ahmed, N. Kharche, M. Korkusinski, M. Usman, M. Parada, T. Boykin, IEEE Trans. Elect. Dev. 54 (2007) 2090.

### Computation and Processing of STM Images

The computation of STM images is performed by coupling atomistic tight-binding wave function calculation with the Bardeen's tunnelling current formalism [J. Bardeen, Phys. Rev. Lett. 6 (1961) 57]. The wave function is decayed in the vacuum region above the reconstructed silicon surface based on the Slater orbital real-space representation [J. C. Slater, G. F. Koster, Phys. Rev. 94 (1954) 14981. For the calculation of tunnelling current, the dominant contribution is from the d

$${z}^{2} - \frac{1}{3} {r}^{2}$$

tip orbital, which is computed by applying the derivative rule reported by Chen [C. J. Chen, Phys. Rev. B 42 (1990-I) 8841.]:

$${I}_{T} ( {r}_{0} ) ∝ {\vert \frac{2}{3} \frac{{\partial }^{2} {Ψ}_{D} ( r )}{\partial {z}^{2}} - \frac{1}{3} \frac{{\partial }^{2} {Ψ}_{D} ( r )}{\partial {y}^{2}} - \frac{1}{3} \frac{{\partial }^{2} {Ψ}_{D} ( r )}{\partial {x}^{2}} \vert}_{{r}_{0}}^{2}$$

where Ψ_{D} is the donor wave function and r₀ is the position of the STM tip. Each computed STM image is spanned over 8×8 nm² area and consists of about 534×534 pixels. Each pixel is computed from the contribution of 3000 atoms directly below it.

### Computer System

FIG. 22 illustrates a computer system 2201 for measuring locations of multiple closely spaced donor atoms implanted into a semiconductor crystal lattice. The computer system 2201 comprises a processor 2202 connected to a program memory 2203, a data memory 2204, and a data port 2206. The program memory 2203 is a non-transitory computer readable medium, such as a hard drive, a solid-state disk or CD-ROM. Software, that is, an executable program stored on program memory 2203 causes the processor 2202 to perform the method in FIG. 1, that is, processor 2202 receives image data, applies a trained machine learning model on the image data to classify the image data into one of multiple candidate configurations and then determines the locations of the dopant atoms based on the model output. The term “determining a location” refers to calculating a value that is indicative of the location. This also applies to related terms.

The processor 2202 may then store the classification or location on data store 2204, such as on RAM or a processor register. Processor 2202 may also send the determined location via communication port 2206 to a server, such as manufacturing control system that adjusts the manufacturing based on the location. In another example, the locations are used to determine a control regime based on the locations. For example, the locations define the interactions between the qubits and therefore, the control sequences applied to the quantum computer should reflect those locations for each chip.

The processor 2202 may receive data, such as STM image data, from data memory 2204 as well as from the communications port 2206. There may be a user port, which is connected to a display that shows a visual representation of the dopant atoms to a user. In one example, the processor 2202 receives STM image data from the STM imager via communications port 2206, such as by using a Wi-Fi network according to IEEE 802.11. The Wi-Fi network may be a decentralised ad-hoc network, such that no dedicated management infrastructure, such as a router, is required or a centralised network with a router or access point managing the network.

In one example, the processor 2202 receives and processes the STM image data in real time. This means that the processor 2202 determines the location every time STM image data is received from the STM and completes this calculation before the STM sends the next image data update.

Although the communications port 2206 is shown as a distinct entity, it is to be understood that any kind of data port may be used to receive data, such as a network connection, a memory interface, a pin of the chip package of processor 2202, or logical ports, such as IP sockets or parameters of functions stored on program memory 2203 and executed by processor 2202. These parameters may be stored on data memory 2204 and may be handled by-value or by-reference, that is, as a pointer, in the source code.

The processor 2202 may receive data through all these interfaces, which includes memory access of volatile memory, such as cache or RAM, or non-volatile memory, such as an optical disk drive, hard disk drive, storage server or cloud storage. The computer system 2201 may further be implemented within a cloud computing environment, such as a managed group of interconnected servers hosting a dynamic number of virtual machines.

It is to be understood that any receiving step may be preceded by the processor 2202 determining or computing the data that is later received. For example, the processor 2202 determines STM image data, such as by applying a pre-filter, and stores the STM image data in data memory 2204, such as RAM or a processor register. The processor 2202 then requests the data from the data memory 2204, such as by providing a read signal together with a memory address. The data memory 2204 provides the data as a voltage signal on a physical bit line and the processor 2202 receives the image data via a memory interface.

It is to be understood that throughout this disclosure unless stated otherwise, nodes, edges, graphs, solutions, variables, locations, classifications, models and the like refer to data structures, which are physically stored on data memory 2204 or processed by processor 2202. Further, for the sake of brevity when reference is made to particular variable names, such as “location” or “probability” this is to be understood to refer to values of variables stored as physical data in computer system 2201. FIG. 1 is to be understood as a blueprint for the software program and may be implemented step-by-step, such that each step in FIG. 1 is represented by a function in a programming language, such as C++ or Java. The resulting source code is then compiled and stored as computer executable instructions on program memory 2203.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for automatic determination of locations of one or more closely spaced donor atoms implanted into a semiconductor crystal lattice, the method comprising:
receiving image data generated by a scanning tunnelling microscope (STM), the image data being indicative of a tunnelling current between a scanning tip and the crystal lattice at multiple image locations;
applying a trained machine learning model to the image data to determine a classification into one of multiple candidate configurations of the one or more donor atoms, wherein the multiple candidate configurations relate to different locations of the one or more donor atoms in the semiconductor crystal lattice; and
based on an output of the trained machine learning model, determining the location of the one or more donor atoms in the semiconductor crystal lattice.

2. The method of claim 1, wherein the semiconductor crystal lattice forms dimer rows of dimer row atoms and the trained machine learning model uses features that are based on an intensity of individual dimer row atom features in the image data.

3. The method of claim 1, wherein the trained machine learning model generates an output that is indicative of a selected one of the multiple candidate configurations and the location is determined as the location related to the selected one of the multiple candidate configurations.

4. The method of claim 1, wherein the trained machine learning model is trained using training samples and the training samples are labelled with identifiers of the multiple candidate configurations.

5. The method of claim 1, wherein the multiple candidate configurations are based on a symmetry of locations of the multiple donor atoms.

6. The method of claim 5, wherein the symmetry is in relation to a dimer row.

7. The method of claim 6, wherein the symmetry is defined by one or more symmetry axes that are parallel and normal to the dimer row, respectively.

8. The method of claim 6, wherein the method further comprises applying the symmetry to reduce a number of training images.

9. The method of claim 1, wherein the image data covers a cluster of multiple donor atoms and the multiple candidate configurations relate to how many donor atoms are in the cluster of donor atoms and the method comprises based on an output of the trained machine learning model, determining how many donor atoms are in the cluster.

10. The method of claim 9, wherein the multiple candidate configurations are related to two donors with one shared electron.

11. The method of claim 10, wherein the two donor locations are constrained by one or more of the following constraints:
the multiple donor atoms are in the same layer; and
the distance between the multiple donor atoms is 1 or more lattice sites.

12. The method of claim 10, wherein
the two donors comprise a first donor and a second donor;
the trained machine learning model uses numeric labels; and
the numeric labels are indicative of a relative position of the second donor relative to the first donor.

13. The method of claim 1, wherein the method comprises training an untrained machine learning model to obtain the trained machine learning model based on one or more of:
experimental STM images;
spectroscopic measurements; and
simulated STM images comprising simulated noise.

14. The method of claim 13, wherein the simulated noise is based on a planar variation where a gradient across the simulated STM images defines a difference in percentage variation.

15. The method of claim 14, wherein the method comprises generating the simulated images for different values of the planar variation.

16. (canceled)

17. The method of claim 1, wherein the trained machine learning model uses features that are based on one or more of:
rotated images to align a dimer row between multiple images;
feature detected edges; and
images with empty spaces removed.

18. The method of claim 1, wherein the trained machine learning model uses features that are based on averages across dimer rows and atoms along the dimer rows.

19. The method of claim 17, wherein the averages form low-resolution two-dimensional images with the dimer rows and atoms as respective dimensions and the trained machine learning model uses the low-resolution two-dimensional images as features.

20. A non-transitory computer readable medium with software code stored thereon that, when executed by a computer, causes the computer to perform the method of claim 1.

21. A computer system for automatic determination of locations of one or more closely spaced donor atoms implanted into a semiconductor crystal lattice, the computer system comprising:
a memory to store or an input port to receive image data generated by a scanning tunnelling microscope (STM), the image data being indicative of a tunnelling current between a scanning tip and the crystal lattice at multiple image locations; and
a processor programmed to:
apply a trained machine learning model to the image data to determine a classification into one of multiple candidate configurations of the one or more donor atoms, wherein the multiple candidate configurations relate to different locations of the one or more donor atoms in the semiconductor crystal lattice, and
based on an output of the trained machine learning model, determine the location of the one or more donor atoms in the semiconductor crystal lattice.
